(19) United States
(12) Patent Application Publication
(10) Pub. No.: US 2013/0317887 A1
(43) Pub. Date: Nov. 28, 2013

(54) DYNAMIC CAMPAIGN SUPPORTER SYSTEM FOR MOBILIZING CAMPAIGN SUPPORTERS

(71) Applicant: Wiliam H. Rhodes, Greer, SC (US)

(72) Inventor: Wiliam H. Rhodes, Greer, SC (US)

(21) Appl. No.: 13/888,001

(22) Filed: May 6, 2013

Related U.S. Application Data
(60) Provisional application No. 61/643,161, filed on May 4, 2012.

(51) Int. Cl. G06Q 30/02

(52) U.S. Cl. CPC G06Q 30/0205
USPC 705/7.32; 705/7.34

(57) ABSTRACT

A dynamic supporter analysis system for mobilizing supporters comprising: a set of computer readable instructions embodied in a central server for receiving the geographical location of the portable computing device, determining an operational location from the geographical location of the portable computer device, constructing a set of streets within a predetermined proximity to the portable computer device based upon the operational location, retrieve voter records according to the streets and the clues to construct a set of target supporters located on at least one street in the set of streets, transmitting the target supporters to the portable computer device, receiving supporter selection information from the portable computer device, transmitting supporter information for the selected supporter, receiving supporter update information from the portable computer device and updating the voter record of the selected supporter with the supporter update information.

### FIELD OF THE INVENTION

This invention is directed to a system for dynamic analysis for identifying potential campaign supporters and assisting with increasing such supporters voting activity. There is a long felt need for a system that efficiently allows for dynamic management and analysis of voter during a campaign and specially on voting day that has not previously been achieved.

### BACKGROUND OF THE INVENTION

In campaigns, there is a large effort given to “getting the vote out” a tremendous amount of energy is directed to having voter actually exercise their right to vote. In looking at historical information from the past few presidential elections, the voter turnout is between 50% and 58%. In Virginia, voter turnout is between 35% and 65% in the elections between 2004 and 2010. Therefore, it is highly desirable for candidates and campaigns to be able to get their supporters to the voting polls.

In any campaigns including political elections, most candidates approach the logistics of reaching voters by organizing their efforts by districts, or precincts. For example, a state house of representatives district may have 35,000 registered voters residing in the district. However, the candidate does not want to need to reach each of these voters. For example, if the candidate is a republican candidate, the candidate does not want to send mailers, knock on doors or call democratic voters since this may results in more democratic voters becoming aware of the election and getting out to vote. Further, and by way of example, of the 35,000 registered voters, only 10% or 15% may vote regularly, especially if the election is a primary of special election. Therefore, it would be advantageous to know the voter characteristics for the political area when conducting a campaign and target the campaign activities on these likely supporters, especially if these supporters are likely to vote. It would also be very advantageous to be able to determine which of the likely supporters have not voted prior to the close of the polls.

Currently, various databases exist for storing voter information throughout the country. Each state generally has an election commission which contains the registered voter and other information such as age, gender, race, voting history and the like. However, this information is generally difficult to use as it is contained in a large database organized either at the state level or broken into political divisions. Further, the database is difficult to search and not designed to address specific candidates or campaign needs. For example, if the candidate wishes to walk a neighborhood, the candidate needs to know the streets that contain voters that are potential supporters so that the candidate can be presented with a list of addresses to target, allowing the candidate of campaign to selectively knock on doors and visit desirable, potential voters.

It would also be advantageous to have information concerning the likely position on the voter prior to conducting a campaign and prior to contacting the voter in order to determine, before communicating with the voter, if the voter is a likely support or not. Traditionally, the systems for managing potential voters focuses on past information such as voting history and on exit polls. Obviously, there is little benefit in a pro-active campaign to contact voter after they have cast their vote.

On voting day, it would be advantageous to have information concerning whether potential supporters have already voted or not, prior to the close of the polls. With this information, the candidate or campaign could better “get the vote out”.

Further, if a candidate or some other entity wishes to conduct a survey of the voters, the candidate or entity would also wish to have some preliminary information concerning the voter prior to asking the voter to participate in the survey. Survey responses are currently collected and aggregated into a database for further study. Unfortunately, associating survey results with voter indicators to indentify likely supporter during an election or campaign is an area that little attention has been directed. Traditionally, any correlation has been preformed post-election.

During an election, it can be discovered that voters wish to be a volunteer for the candidate or campaign, host an event for a candidate, donate to the candidate, or otherwise express their support for the candidate or campaign. When the voter takes such initiative, the candidate of campaign should act quickly to respond to the voters desires. For example, in the event that the voter states that the voter would be interested in a sign placed in his or her yard, the sign should arrive at the voter's location as soon a possible. When the voter wishes to make a donation, the candidate or campaign should be ready to take the donation virtually immediately.

Therefore, it is an object of the present invention to provide a system for performing voter information as soon as possible, to an individual that wishes to communicate with potential voters.

It is also an object of the present invention to provide for a system that can identify potential supporters and allow a candidate to contact the supports prior to the closing of polls when it is discovered that the potential supporter has not voted.

It is also an object of the present invention to identify and associate voter clues with potential voters to assist with the determination if the voter is a likely supporter.

It is also an object of the present invention to incorporate survey results with voter information to assist with the determination if the voter is a likely supporter.

### SUMMARY OF THE INVENTION

The object of the present invention is accomplished by providing a dynamic campaign supporter analysis system for mobilizing campaign supporters comprising: a central server, the central server having a non-transitory computer readable medium and in communications with a portable computer device; a user database in communications with the central server having user records containing user information; a voter database in communications with the central server having voter records containing supporter information, the voter information includes voting clues and survey results; and, a set of computer readable instructions embodied in the central server.

The set of computer readable instructions are executed by a processor that is included in the central server and adapts the central server from a general purpose computer into a computer that performs the functions of: receiving user login information, retrieving user authorization information from the user database including the geographic limitations for the user and the supporter information limitations for the user, receiving the geographical location of the portable computing device, determining an initial operational location from the geographical location of the portable computer device, transmitting the initial operational location to the portable computer device, receiving an acceptance or rejection by the user of the initial operational location, if the initial operational location is accepted, setting the operational location to the initial operational location, if the initial operational location is rejected, receiving a manual operational location from the portable computer device and settling the operational location to the manual operational location, determining if the user of the portable computer device is authorized to perform actions in the operational location from the user authorization information, constructing a set of streets within a predetermined proximity to the portable computer device based upon the operational location, retrieving voter records according to the streets and the supporter information to construct a set of target supporters located on at least one street in the set of streets, transmitting the target supporters to the portable computer device, receiving supporter selection information from the portable computer device, transmitting supporter information for the selected supporter filtered by the user authorization information, receiving supporter update information from the portable computer device and updating the voter record of the selected supporter with the supporter update information, receiving notes from the portable computer device, associating the notes with the selected supporter, storing the notes in the voter database, transmitting a request for voting clues to the portable computer device, receiving voting clues from said portable computer device, updating the voter database with the voting clues, transmitting survey questions to the portable computer device, receiving survey answers from the portable computer device, associating the survey answers with the selected supporter, updating the selected supporter record with the received survey answers, generating a report and transmitting the generated report to a computer device.

The system can include voting clues taken from the group consisting of: voting history, republican indicators, democratic indicators, right to life/abortion indicators, bumper stickers, tax indicators, home schooling indicators, gun rights/gun control indicators, sports indicators, flags, government comments and yard signs. The users can have the status selected from the group consisting of: national administrator, national user, state administrator, state user, county administrator, county user, precinct administration and precinct administrator.

The system can include computer readable instructions for constructing a set of streets within a predetermined proximity, to the portable computer device based upon the operational location, only including streets within the county associated with the user for county users or can only include streets within the precinct associated with the user for precinct users.

The system can include supporter information that has campaign information taken from the group comprising of: supporter, volunteer, donor, sign, bumper sticker, t-shirt and host.

The system can include computer readable instructions for generating a set of voters organized by precinct, indicating which voter in the set is a supporter, volunteer or donor, transmitting the set of voters to the portable computer device, receiving vote information from a user, serving as a poll watcher, indicating whether a selected voter from the set has voted, generating a subset of voters from the set of voters of voters that are supporters, volunteers and donors that have not voted and transmitting the subset to a computer device so that supporters, volunteers and donors can be contacted and reminded to vote. The subset of voters can includes phone number, text and email contact information for the voters that have not yet voted.

The system can include computer readable instructions for generating a report having a set of voters organized by precinct and indicating in the report which voter in the set is a supporter, volunteer, donor or likely supporter based upon voting clues or survey results so that a poll watch report can be provided to a poll watcher.

The system can include computer readable instructions for receiving voter information from a user serving as a poll watcher, updating the set of voters to indicate which voter has voted and which voter has not, generating a subset of voters from the set of voters that are supporters, volunteers and donors that have not voted and generating a report showing which voter is a supporter, volunteer or donor that has not yet voted so that such voter can be can be contacted and reminded to vote.

The system can include computer readable instructions for receiving voter information from a user serving as a poll watcher, updating the set of voters to indicate which voter has voted and which voter has not, generating a subset of voters from the set of voters that are supporters, volunteers and donors that have not voted transmitting the subset to a computer device so that a user of the computer device can receive real time information concerning the number of supporters, volunteers and donors that have voted compared to those that have not voted.

### DESCRIPTION OF THE DRAWINGS

FIG. 1 is a schematic of the invention;

FIG. 2 is a schematic of the invention;

FIGS. 3A and 3B are flowcharts of the invention;

FIG. 4 is a schematic of the invention;

FIG. 5 is a schematic of the invention;

FIG. 6 is a schematic of the invention; and,

FIGS. 7 through 9 are flowcharts of the invention;

### DESCRIPTION OF THE INVENTION

Computer readable instructions, when executed by a computer processor, cause the computer to perform a series of unique steps to accomplish a specific task and resulting in useful, concrete and tangible results. These computer readable instructions can adapt a general purpose computer into one that is specific to the functionality described herein. This computer readable code is tied to a particular machine or apparatus with the specific purpose of executing the computer readable code for accomplishing tangible results and representing and accomplishing the manipulation of physical data.

The detailed description that follows may be presented in terms of program procedures executed on a computer or network of computers. These procedural descriptions are representations used by those skilled in the art, to most effectively convey the substance of their work to others skilled in the art. These procedures herein described are generally a self-consistent sequence of steps leading to a desired result, when executed by a computer and its processor representing or resulting in the tangible manipulation of physical objects. These steps also require physical manipulations of physical quantities such as electrical or magnetic physical elements and are capable of being stored, transferred, combined, compared, or otherwise manipulated readable medium that is designed to perform a specific task or tasks.

Actual computer or executable code or computer readable code may not be contained within one file or one storage medium, but may span several computers or storage mediums. The term “host” and “server” may be hardware, software, or a combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. The blocks of the flowchart, functionality described herein and computer code itself include algorithms to provide the claimed invention. Elements of the flowchart support combinations of means for performing the special functions, combinations of steps for performing the specified functions and program instruction means for performing the specified functions. It will be understood that each block of the flowchart illustrations can be implemented by special purpose hardware-based computer systems that perform the specified functions, or steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

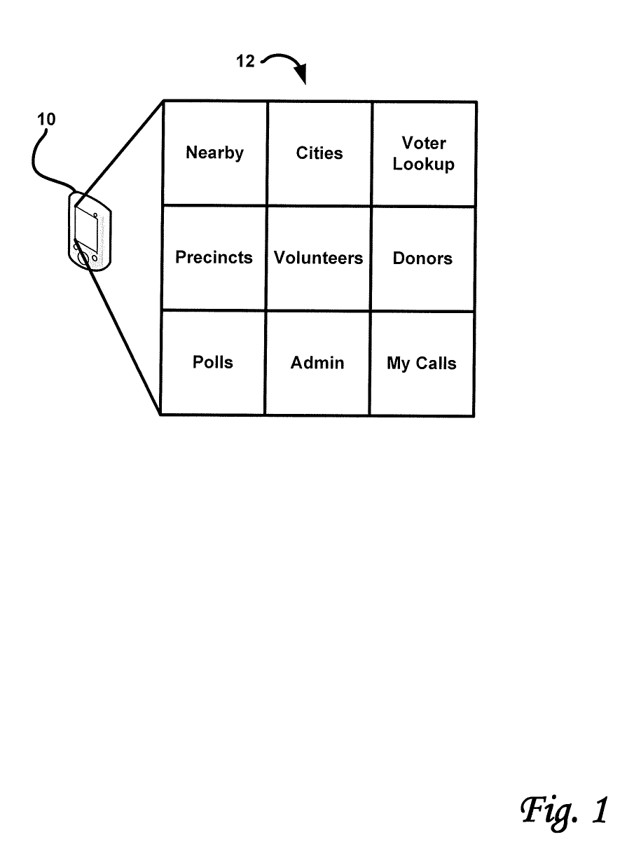

Referring to FIG. 1, a smart phone, tablet or other portable computing device 10 has a user screen (dashboard) 12 that contains one embodiment of user selectable options representing user input to access the functionality of the current invention. The section Nearby uses strong Google maps integration GPS information gathered from the PDA and locates the user location. Using this information, the PDA retrieves street names that are in close proximity and displays the streets on the PDA display. The distance from the current user's location is associated with each street and provided to the user. From the lists of streets, the user can select a specific street and when that street is selected, street detail information is displayed in house number order. In Table 1, an example of the display is shown including the house number, street name and number of registered voters located at the address.

TABLE 1

| | | |
|---|---|---|
| 101 | Hudson Road | 2 |
| 102 | Hudson Road | 2 |
| 103 | Hudson Road | 4 |
| 104 | Hudson Road | 2 |
| 105 | Hudson Road | 2 |
| 106 | Hudson Road | 2 |

It should be noted that the streets are ordered by house number. However, in the event that the user wishes to “walk the street” and use the PDA to see a walk list, the houses on the list can be ordered so that the user can walk down one side of the street and then back down the other side of the street as shown in Table 2.

TABLE 2

| | | |
|---|---|---|
| 101 | Hudson Road | 2 |
| 103 | Hudson Road | 2 |
| 105 | Hudson Road | 4 |
| 106 | Hudson Road | 2 |
| 104 | Hudson Road | 2 |
| 102 | Hudson Road | 2 |

With the listing of the individual addresses, the user can request a map to be displayed which is then displayed on the portable computing device. Each address can be shown on the map through a location indicator representing a voter or filtered to only represent potential supporters. In one embodiment, the display can only include voters that are taken from the group consisting of: republicans, democrats, selected voting histories, supporters, volunteers, donors and clues. The map can be a virtual map, road map or real satellite imagery overlaid with voter location indicators. From the list of individual address or from the map, an address can be selected. In this case, the individual voter data can be displayed associated with that address. An example of this is shown in Table 3 showing the name, age, gender and race of the voter or voters residing at the physical location. Potential individual voter data can include voting history, party, survey responses, memberships or other information gathered and associated with the voter.

TABLE 3

| | |
|---|---|
| Survey: XX | Name of Voter |

| | | |
|---|---|---|
| Age: XX | Gender: XX | Race: XX |

| | |
|---|---|
| Survey: XX | Name of Voter |

| | | |
|---|---|---|
| Age: XX | Gender: XX | Race: XX |

From Table 3 you can see that there is an indicator associated with the Name that can indicate whether the voter has been surveyed or not (such as showing a check mark beside the individuals name). Therefore, the user of the portable computing device can request form the voter whether voter would be interested in taking a survey.

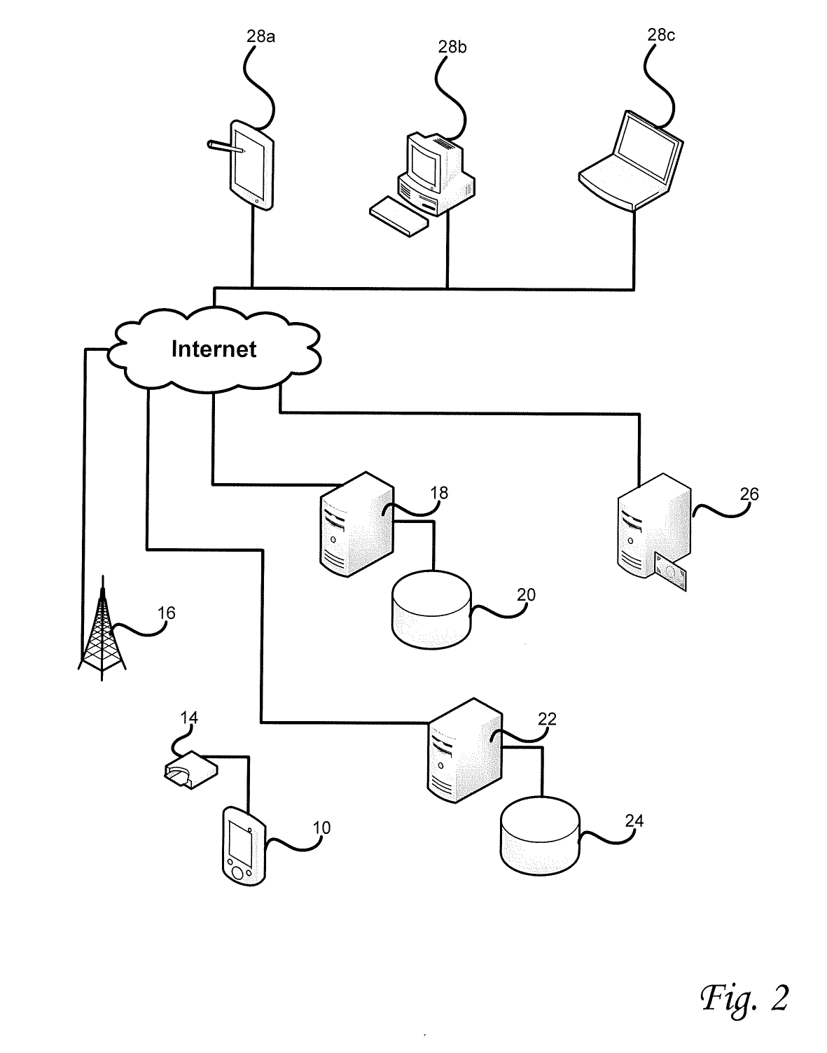

Referring to FIG. 2, portable computing device 10 is shown having a credit card reader 14 in wireless communications to a wide area network such as the Internet. A wireless transceiver 16 can be used to send and receive electronic information to and from the portable computing device in real-time, at predetermined times or at the request of the user. Wireless communications can include Wi-Fi, cellular, or other wireless networks. A central server 18 can have a database 20 which can contain other databases as well as election information such as precincts and the like. The central server can be in communication with other servers 22 and databases 24 such as the federal voter database, state election commissions, or country voter organizations allowing the central server to have access to voter information from multiple sources beyond the information stored on the central server or information collected from the portable computer device. This allows the voter information that is collected from the portable computer device to be shared with third party systems. For example, if the voter information is updated to correct an email address or phone number, this information can be shared with third party organizations to provide a more reliable voter information infrastructure for a local, regional or national groups.

In the event that the user identifies a donor and is able to collect a donation for a political candidate, party, group, political action committees or the like, the user can swipe a credit card or debit card using the credit card reader 14. The information can then be processed through a clearing house 26 so that the donor's account is debited and the beneficiary of the donation account is credited. The voter can have the voter information in the voter database updated to reflect that the voter is a donor for that particular election, candidate or campaign.

The information that is collected from the portable computing device can be transmitted to the central server in real time through a wireless network, can be transmitted on a predetermined schedule, or can be downloaded in batch with a wireless or wired connection.

Once the information is downloaded to the central server, it can be accessible through a wide area network such as the Internet to other access points devices 28a through 28c and therefore other individuals. When information is recorded from the portable computing device 10 and transmitted to the central server, it can also generate a work order almost immediately, according to the information generated. For example, if the user of the portable computing device 10 records the voter's willingness to have a yard sign placed in the voter's yard, the central server can transmit a notification for yard placement to an individual also having a portable computer device thereby providing immediate notification that a sign should be placed in the voter's yard. With this information, it would be possible to have the individual in charge of sign placement travel to the voter's location with a yard sign almost immediately upon receiving a request to greatly reduce the time between the voter wanting a sign and the sign being placed.

In one embodiment, the central server can create a sign placement list which provides the individual placing signs with route data that can be used so that the signs are placed in a geographic order to minimize the travel time and distance traveled by the individual placing signs.

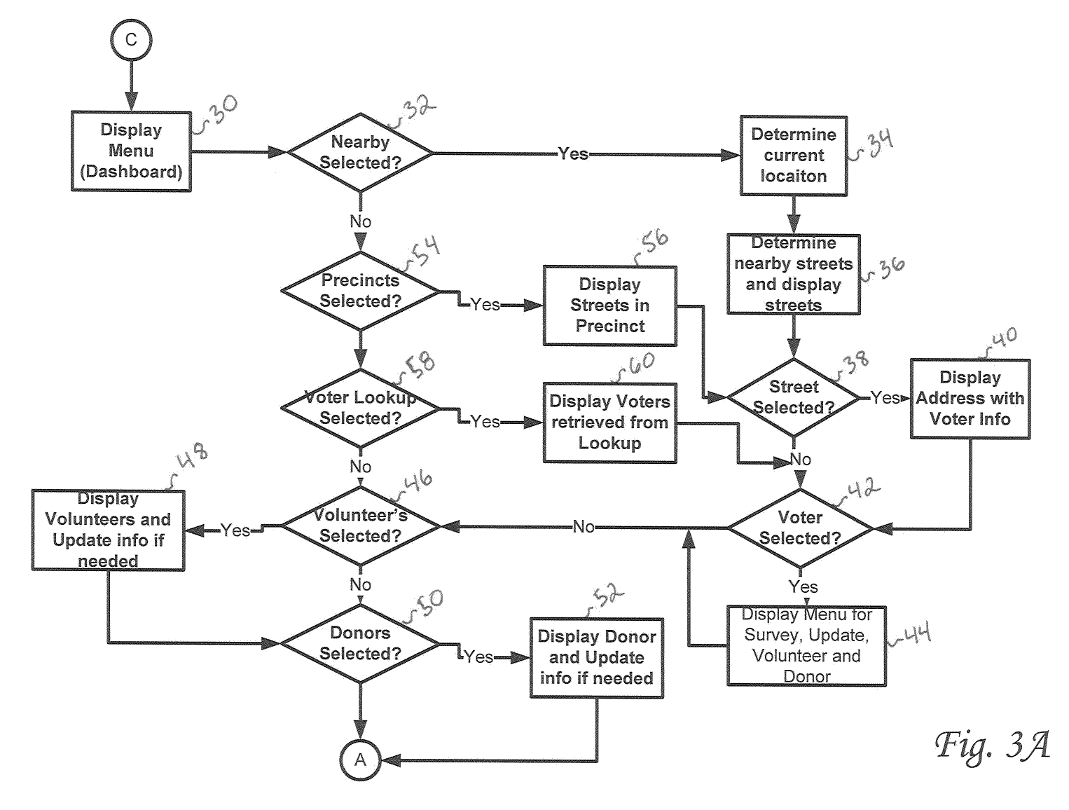

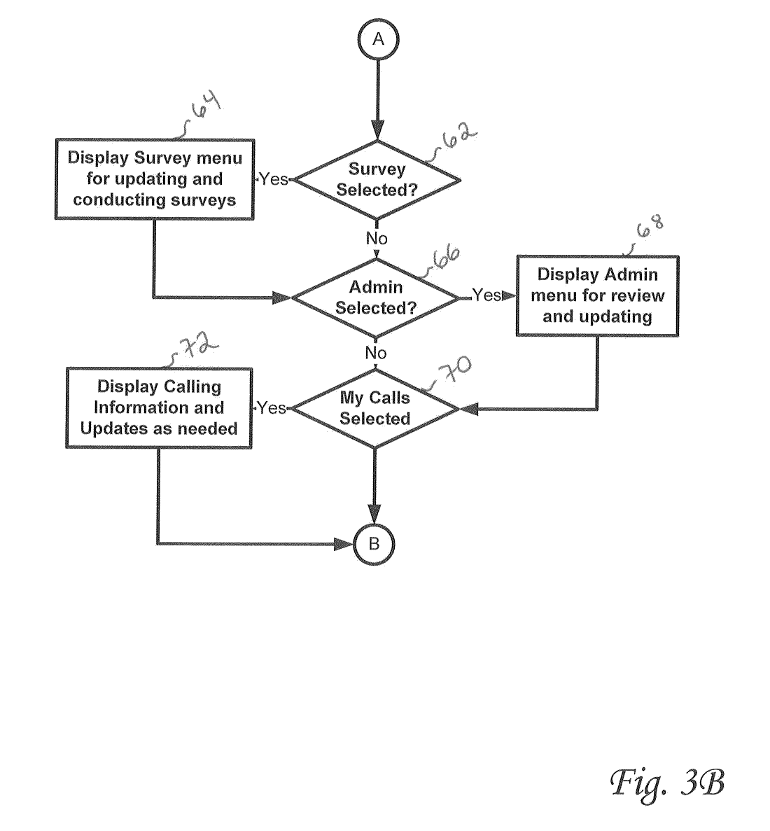

Referring to FIGS. 3A and 3B, the functionality provided by the computer readable instructions is shown in more detail. At 30, the portable computing device accesses the central server and, in one embodiment using SaaS, retrieve display information for displaying the user interface to the user. The portable computing device then retrieves its physical location from global positioning system such as GPS, triangulation with cellular networks and transmitters its physical location to the central server. The computer readable instructions on the central server can then determine an initial operational location and transmit it to the portable computing device. For example, if the portable computing device is located at a physical address on Street A, the central server can transit to the portable computing device an operational area that includes Street A and the adjoining streets and voter addresses within a predetermined distance. In one embodiment, the predetermined distance is established by defining a geographic area with a perimeter where the user of the portable computing device is to operate. In one embodiment, the predetermined distance is determined by the geographic area feet or by the end of a street. Therefore, the user would have an operational location that would not extend past the end point of a relevant street. This is desirable as streets can be split between two precincts. This information can be displayed graphically or textually to the user of the portable computer device.

In one embodiment, the user can reject the initial operational location and enter another operational location manually. This function would assist the user to determine the size of the operational area without having to physically travel to the operational area to determine its size. The user can then transmit a manual operational area to be received by the central server. The central server can determine, based upon the user information, whether the user is authorized to perform activities in the operational area from the user information and either allow the user to proceed or inform the user that the user is exceeding the user's authority and not allow the user to proceed.

In one embodiment, the user can select the Nearby function 32. This function cause the computer readable instructions of the central server to receive the physical location of the portable computing device at 34. The central server then determines the streets that are in close physical proximity to the current location of the portable computing device at 36. The streets that are selected can be displayed graphically or textually to the user. The central server can then receive street selection information from the portably computing device at 38. If a street is selected, the central server retrieves the voter information for the voter database and can filter the voter information so that only supporters or likely supporters are transmitted to the portable computing device at 40. Therefore, the user of the portable computing device would only contact those that were supporters or likely supports so that the “get the vote out” was directed to such individual only.

If a voter is selected by the user of the portable computing device at 42, the voter information is transmitted to the portable computing device for display to the user at 44. If no voter is selected, the process requests if a volunteer is selected at 46. If so, the volunteer information is displayed and updated if needed at 48. A donor may be selected at 50. If so, the donor information is displayed and updated if needed at 52. If the user selects a precinct at 54, the streets in the precinct are displayed at 56 and the process continues on to 38. If voter lookup is selected at 58, voter information is displayed at 60 and the process continues to 42.

Referring to FIG. 3B, if a survey is selected at 62, the survey is displayed and survey results are received by the central server at 64. The survey results can be stored on the central server and can be associated with a selected voter participating in the survey. If administration functions are selected at 66, the administrative functions are displayed at 68 allowing for additions, deletions and modifications of users. User can carry a status of: National Administrator allowing access to all states and sub-categories as well as the ability to add, delete and modify users; National User allowing access to all states voter information and sub-categories; State Administrators allowing access to one or more states and the ability to add, delete and modify user associated with that state; State User can have access to one or more state voter information; County Administrator can have access to one or more county voter information with the ability to add, delete and modify user associated with the respective county; County User can have access to one or more county voter information; Precinct Administrator can have access to one or more precinct voter information with the ability to add, delete and modify user associated with the respective precinct and Precinct User can have access to one or more county voter information.

In one embodiment, the computer readable instruction can create a list of voters from the voter database to be called for various reasons including, campaign messages, surveys or to remind the voter to vote. The call list can be created using several criteria such as voter clues, survey results, voter history, voter demographics, and the like. If the user wishes to make such calls, the user selects the call list at 70 resulting the users call list being displayed to the user at 72.

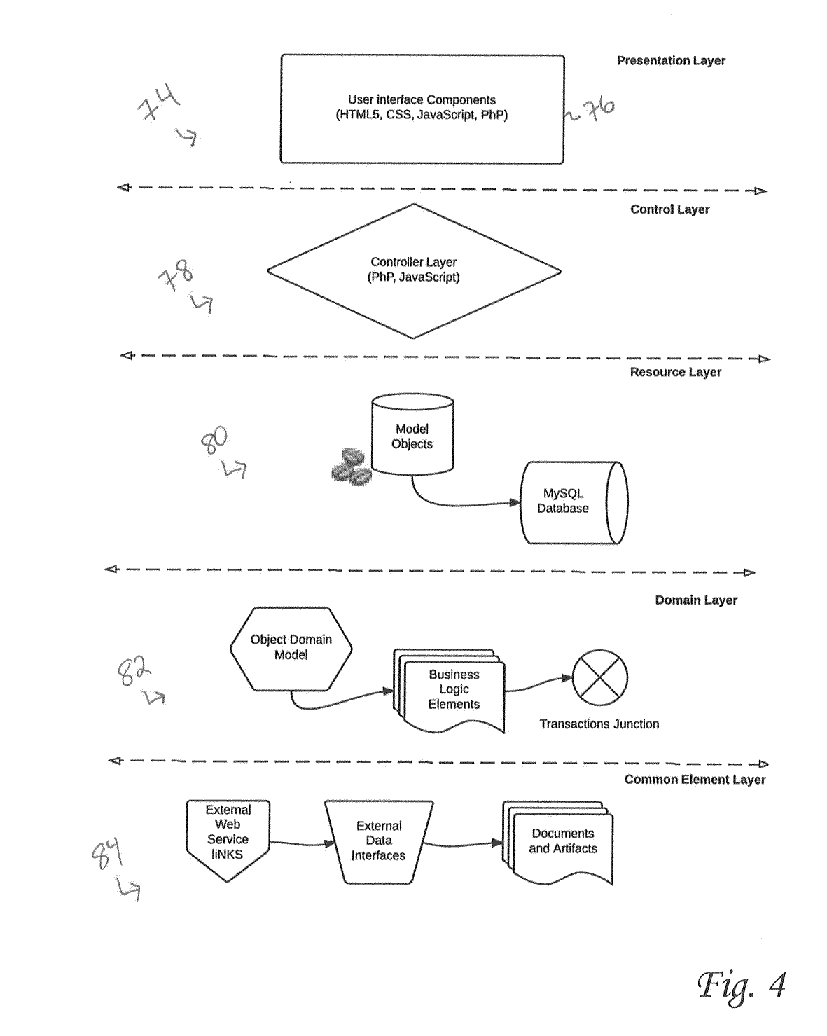

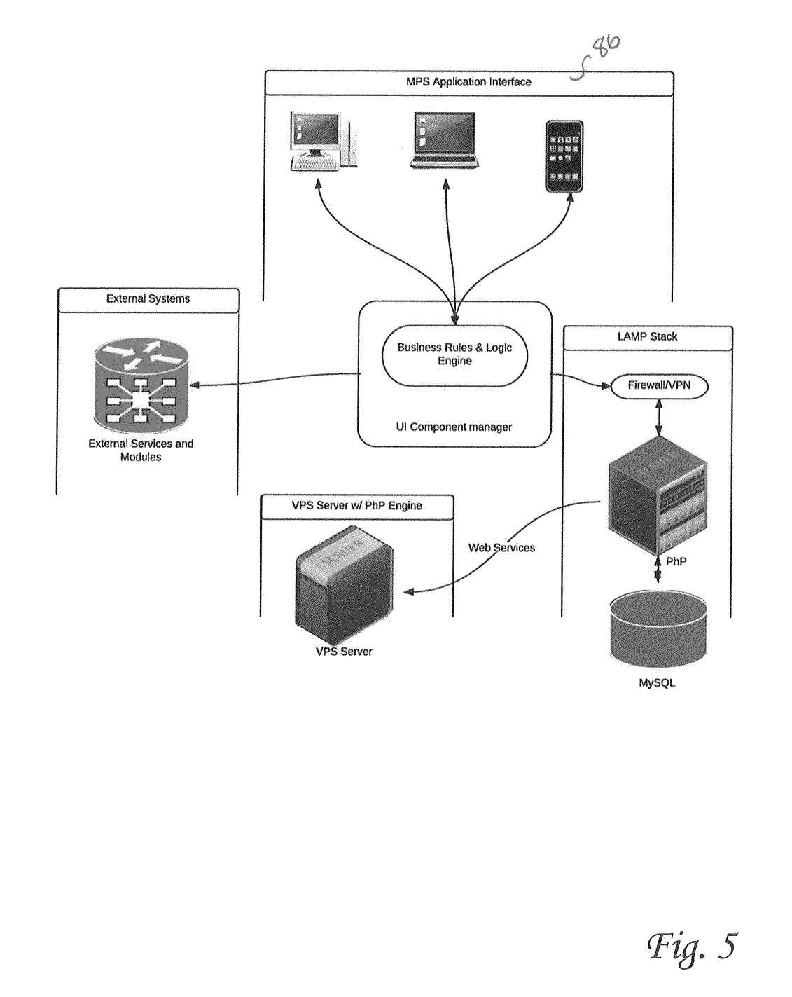

The system that provides for the functionality described herein can have the structure shown in FIG. 4. The presentation layer 74 includes the aspects of the current system associated with the user interface 76 on the central server, portable computing device or other computing device. The control layer 78 provides the functionality of the user interface and its interaction with the data and processing of the underlying central server computer readable instructions. The control layer accesses the resource layer 80 which allows the use of the database access and retrieval of voter information. The domain layer 82 includes the logical decision making of the computer readable instructions and the common element layer provides access to external websites, external data and documents. Referring to FIG. 5, the structure of the system is further explained. The user interface 86 that provides access to the central server can be accessed using a desktop computer 88a, laptop 88b or portable computing device 88c.

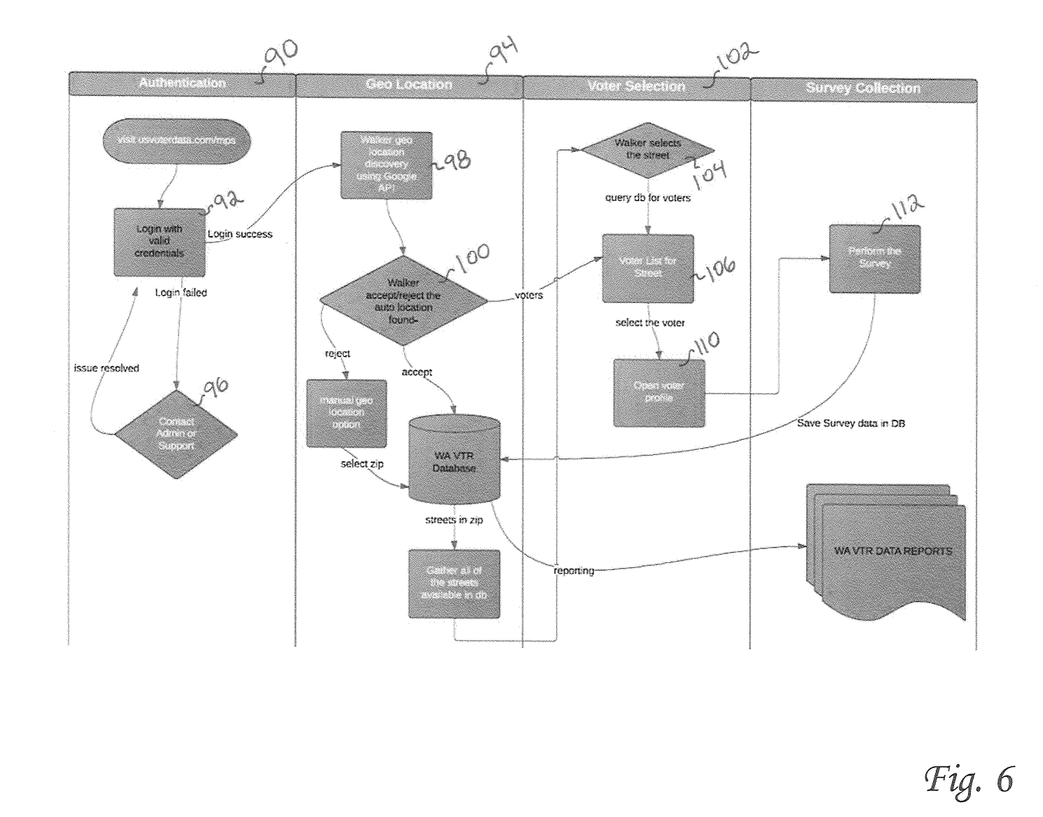

Referring to FIG. 6, the information and data flow of the system in operation is further detailed. When the user of the portable computing device initially attempts to access the system an authentication process is preformed at 90. The user provide credentials at 92 that are received by the central server. If the user is allowed to log in, the user is taken to the geo location step at 94. If the user is unable to log in a message is stored and an administrator or support individual is contacted at 96.

Once identified, the user access is determined including the locations where the user can operate and what information the user can use, modify or access. For example, a precinct user may only be allowed to access information associated with the precinct of the user. Once authenticated, the portable computing device's physical location is determined and received by the central server at 98. The central server then determines an initial operational location and transmits it to the user. The user can then accept the location or provide a manual location at 100. If the user accepts the initial operational location, the operation location is set to the initial operational location at 100. The process can then move to voter selection at 102. At this step the user can select the street which to begin the campaign activity at 104. The central server then retrieves voter information for voter with address on the selected street at 106. The central server can filter the voter information by only including voters that have a certain voting history. For example, if the voter has voted in the last four democratic primaries in the a row, this indicates that the voter is likely to vote democrat in the current campaign or election. Therefore, the user, if involved with a republican campaign, would not be interested in stopping at the residence or otherwise contacting this voter during campaign activity. From the list of displayed voters on the street, the user can select a voter and have voter information displayed on the portable computing device at 110. The user can also update the voter information which can be received by the central server.

When physically visiting the voter or otherwise communicating with the voter, the user of the portable computing device can ascertain voting clues concerning the voter that include indicators taken from the group consisting of: republican voting history, democratic voting history, republican indicators, democratic indicators, right to life/abortion indicators, bumper stickers, tax indicators, home schooling indicators, gun rights/gun control indicators, sports indicators, flags, government comments and yard signs. If the voter has bumper stickers on the voter vehicles, the bumper stickers can indicate the voting history, previous candidates supported by the voter, the voter position on certain political issues such as gun control, right to life, tax position and the like. Examples that assist with a prediction of the voter's position and subsequent voting behavior can include a bumper sticker that sad “AMERICAN TEA PARTY” would indicate a republican voter while a “YES WE CAN” bumper sticker would indicate a democratic voter. The user can enter input concerning such indicators and voting clues so that the central server can update the voter information with these voting clues. From the voting clues, the central server can indicate whether the voter is a likely supporter of the candidate or campaign.

The user can also perform surveys when visiting with a voter at 112. In one embodiment the survey questions can be designed to attempt to assist with predicting the political position of the voter. For example, the following survey questions and survey results can assist with predicting the voting action of the voter:

Question 1. “I am concerned that big-government politicians are bankrupting our country and indebting us and our children.” (a) YES, Extreme concern, (b) YES, slight concern, (c) NO, not a concern—the actions of the current government are necessary for the well being of this Country, (d) NO, this Country is not actually going into bankruptcy;

Question 2. “I believe that the Patient Protection and the Affordable Care Act (ObamaCare) health reform is needed and overall will be good for the Country.” (a) YES, I fully support it, (b) YES, but concerned about its costs, (c) DON'T KNOW, I do not have enough information to answer this question (d) NO, It's a bad law that will do more harm than good;

Base upon the survey results it can be determined that if the voter answers (a) or (b) to Question 1, the voter is likely to support a Republican candidate or issue and if the answer is (c) or (d) the voter is likely to support a Democratic candidate or issue. If the voter answer (a) or (b) to Questions 2, the voter is likely to support a Republican candidate or issue. If the voter answer (d) to Questions 2, the voter is likely to support a Democratic candidate or issue. When designing the survey questions, the answers can be identified to assist with determining if the voter would be a supporter of not. Based upon survey answers, the central server can determine whether the voter is potential supporter of the candidate of campaign.

If the survey option is selected, the user is presented with a series of survey questions that can be posed to the voter. The responses can be recorded by the user and stored in database and associated with the voter. Survey questions can include whether the voter is going to vote in the primary election, who they are voting for President, and other such information. In one embodiment, the responses can be assigned values which can the be used to rank the voters from liberal to conservative minded. Further, values be can assigned to specific answers that allow the invention to identify potential supporters, volunteers or donor and can indicate particular activities that the voter may wish to participate. For example, if the voter is identified as a supporter, the voter can be asked if the voter would like a yard sign and if the voter indicates in the affirmative, that information can be stored on a database as associated with the voter.

In the embodiment that is real-time (e.g. wireless real time communications with a central server), a notification can be generated by the central server to the individual in charge of yard sign placement and a sign can be in route to the voter's address even while the user of the portable compute device is still at the voter's address. Further, if the voter requests or accepts a yard sign, the voter is likely a supporter of the candidate.

In one embodiment, the portable computing device is equipped with a credit card reader allowing credit card information to be received and processed from the voter while at the voters residence. This allows the campaign or candidate to react to receive a donation as soon as possible after the voter is willing to take such action. For example, if a voter stated that he or she would be willing to make a political contribution to the candidate or party, the user can take the credit card of the voter and swipe the card to process a donation right on the spot. When a voter makes a financial donation, the voter is again likely to be a supporter of the political candidate when vote for such candidate. Therefore, the voter information in the voter data can be updated that the voter is a donor.

The Voter Lookup selection allows the user to find a particular voter through search criteria which will take the user to a particular voter record. Once the voter record is retrieved the user can perform the tasks associated with the voter as described herein.

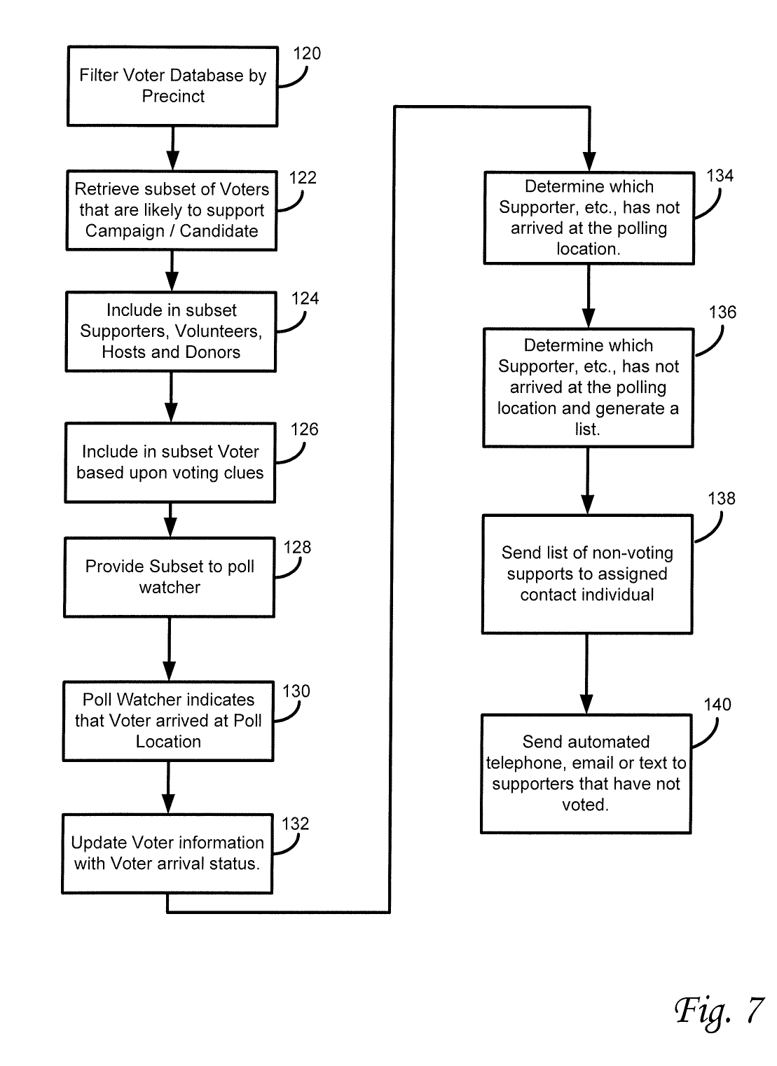

Referring to FIG. 7, the system as it can be used to increase the number of supporters voting is shown. The voter database 120 includes voters for a particular campaign of candidate for a current election. The voters in the database can be filtered by precinct to form a subset of voters. From this subset of the voter information, a database of likely supporters for a particular precinct can be created at 122. This subset can be created by using factors such as voting history. For example, if the voter has voted in the last four republican primaries, it is likely that the voter will vote and that the voter will vote republican. If the voter voted in two of the last four republican primaries, the voter is less likely to vote, but if the voter does vote, likely to vote republican. Therefore, a republican campaign would be interested in a subset of such voters as these voter would likely support a republican candidate and it may be desirable to include these candidates in the subset. Such a voter is one that the candidate would want to communicate with in the “get out the vote” activity.

If the voter has expressly indicated that the voter supports the candidate or campaign, volunteers for the candidate or campaign, or is a donor for the campaign or candidate, the voter is likely to vote for the candidate or campaign. Therefore, the subset can include these supports, volunteers, hosts and donors at 124. There are also voting clues that indicate the voting tendency or habits of a voter as discussed herein. Based upon the clues, the voter can be included in the subset of voters at 126. Once the subset has been created, the list of voter contained on the subset can be provided to poll watchers that are present at the polls on voting (election) day at 128. The poll watchers can indicate which voter has arrived at the poll at 130. This can be accomplished in several ways. First, the subset can be transmitted to the portable computer device that is in the possession of the poll watcher. The poll watcher can assess the system through a web browser or app on the portable computing device. In either case, the poll watcher can indicate which voter has arrived at the polling location at 130. The central server updates the voter data with the information indicating the voters arrival at 132. With this information, it can be determined which supporter of the campaign or candidate has not voted at 134. The computer readable instructions can then generate a list of voters from the subset at 136 that have not arrived at the polling location. Therefore, the campaign or candidate can contact the voter and remind the voter to vote. In one embodiment, the voter in the subset can be assigned to a particular contact individual at 138. At a pre-determined time preceding the closing of the polls, the computer readable instructions can send a message to the contact individual informing the individual which voters in the subset have not arrived at the polling location. The contact individual can then contact the voter to urge the voter to vote in hopes of increasing the supporting voter turnout. In the embodiment when the poll watcher updates the voting record real time, the contact individual can access the central server to avoid the case where delay between the contact person contacting the voter and the poll watcher recording attendance results in a voter that has already voted is contacted to vote. In one embodiment, the voter information includes telephone, email and text information. In this embodiment, the computer readable instructions can include instructions to send an automated telephone call, email or text to the voter reminding the voter to vote. By providing this functionality, the candidate or campaign can increase the chance of winning by having likely supporters reminded to vote and to contact these voters that have not yet voted to go vote before the polls close.

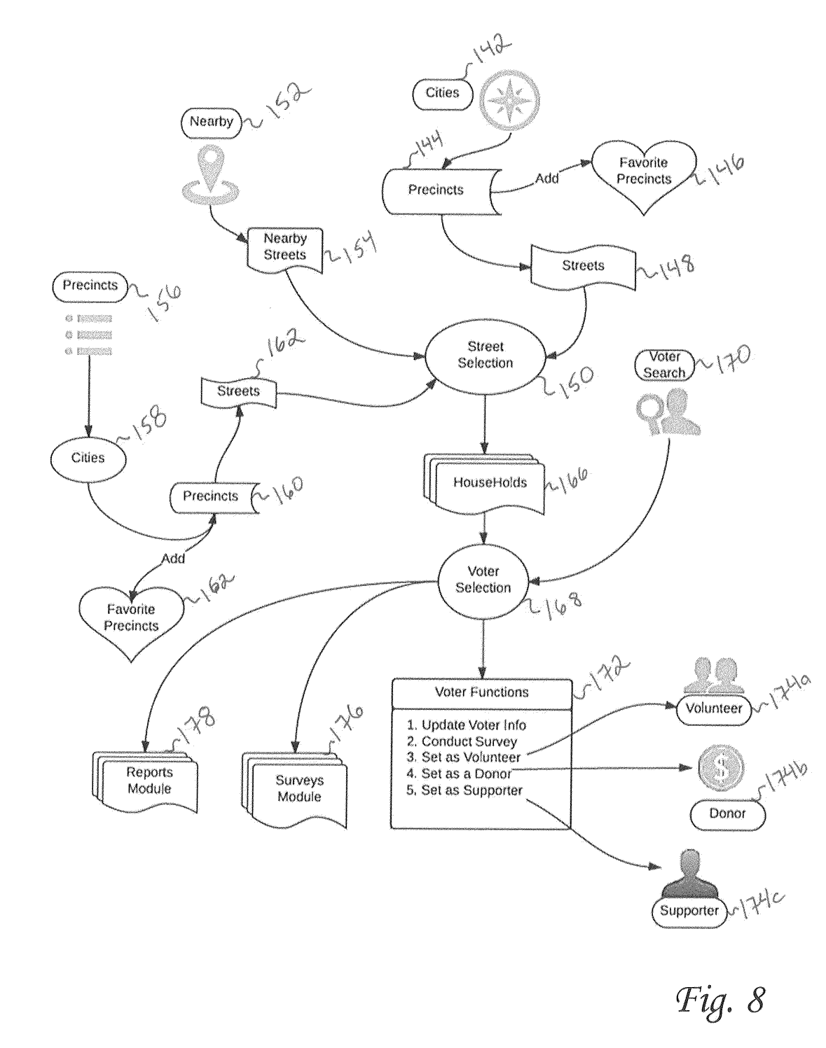

Referring to FIG. 8, the interconnectivity of the functionality of the present invention in one embodiment is further shown. Form the portable computing device, the user can select the city at 142. This selection can be made either by using the physical location obtained from the portable computing device or from a manual entry from the user. The user can then be presented with precincts from the central server that are contained in the city at 144. The user, upon selecting a precinct, can store the precinct as one of the user's favorite places at 146. From the precinct, the user can select streets at 150 from the displayed streets in the precinct displayed at 148.

In one embodiment, the user can select street that are nearby the user's present location at 152. From this option, nearby streets are displayed at 154 and the user can select a street at 150.

The user can also select a precinct from a displayed options at 156. Cities that are within the precinct can be displayed to the user at 158. From this option precincts specific to that city can be displayed at 160. The user can add the precinct to the user's favorite places at 162. From the this precinct, the user can be presented with streets in the precinct at 164 and select a street at 150. Once the user selects a street, households or voter information can be presented that are located on the selected street at 166. In the event a household is selected, the voters that are associated with the household are displayed and the user can select a voter at 168. The user can also have a a voter is list of voters from the central server to the portable computing device by searching for voters at 170. From the voter selection function, the user can update voter information, conduct a survey 176, designate a volunteer 174a, receive a donation 174b, designate as a supporter 174c or associate a voting clue at 172. The user can also create a report, run a pre-existing report or conduct an ad hoc query at 178.

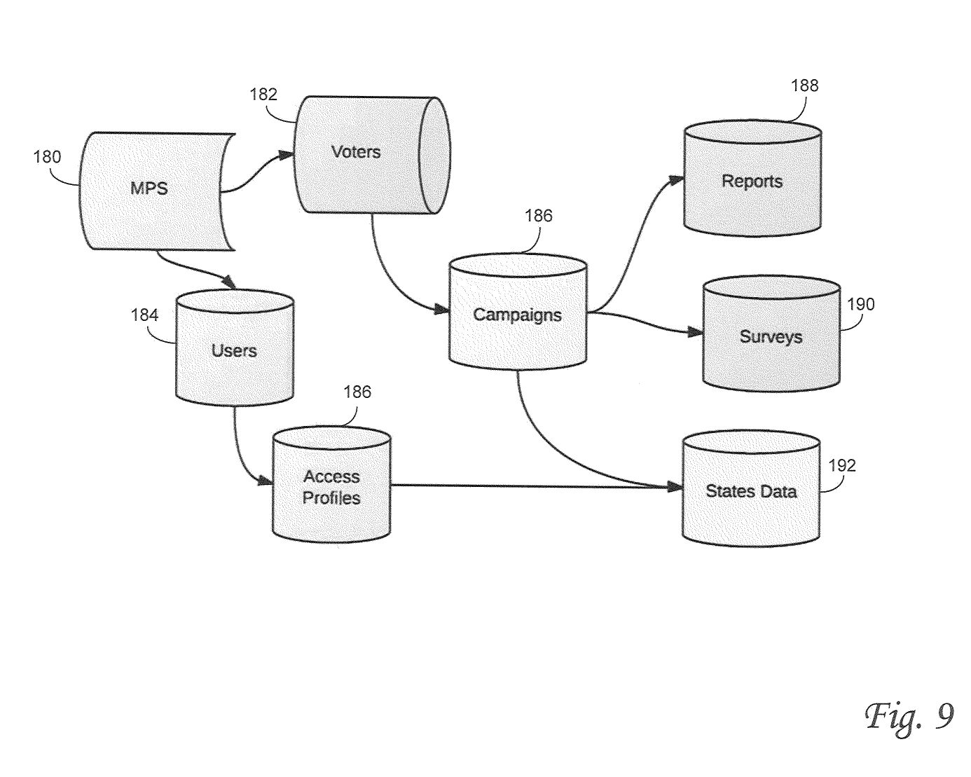

Referring to FIG. 9, the relationship between the various databases and data sources is shown. The computer readable instructions 180 on the central server is shown. The computer readable instructions can access a voter database 182, voter database 184 and an access profile for each user can be contained in access profile database 186. Campaigns can be stored in campaign database 188. Reports, both pre-existing and ad hoc can be stored in report database 188, surveys questions and survey responses can be stored in database 190 and voter information can be stored in database 192. The voter database can be stored in a local database for information added by the user and can also access an external database for voter information.

It is understood that the above descriptions and illustrations are intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A dynamic campaign supporter analysis system for mobilizing campaign supporters comprising:
a central server, said central server having a non-transitory computer readable medium and in communications with a portable computer device;
a user database in communications with said central server having user records containing user information;
a voter database in communications with said central server having voter records containing supporter information, said voter information includes voting clues and survey results; and,
a set of computer readable instructions embodied in said central server that, when executed by a processor included in said central server, adapts said central server to perform the functions of: receiving user login information, retrieving user authorization information from said user database including the geographic limitations for the user and the supporter information limitations for the user, receiving the geographical location of the portable computing device, determining an initial operational location from said geographical location of said portable computer device, transmitting said initial operational location to said portable computer device, receiving an acceptance or rejection by the user of said initial operational location, if said initial operational location is accepted, setting said operational location to said initial operational location, if said initial operational location is rejected, receiving a manual operational location from said portable computer device and settling said operational location to said manual operational location, determining if said user of said portable computer device is authorized to perform actions in said operational location from said user authorization information, constructing a set of streets within a predetermined proximity to said portable computer device based upon said operational location, retrieving voter records according to said streets and said supporter information to construct a set of target supporters located on at least one street in said set of streets, transmitting said target supporters to said portable computer device, receiving supporter selection information from said portable computer device, transmitting supporter information for said selected supporter filtered by said user authorization information, receiving supporter update information from said portable computer device and updating said voter record of said selected supporter with said supporter update information, receiving notes from said portable computer device, associating said notes with said selected supporter, storing said notes in said voter database, transmitting a request for voting clues to said portable computer device, receiving voting clues from said portable computer device, updating said voter database with said voting clues, transmitting survey questions to said portable computer device, receiving survey answers from said portable computer device, associating said survey answers with said selected supporter, updating said selected supporter record with said received survey answers, generating a report and transmitting said generated report to a computer device.

2. The system of claim 1 wherein said voting clues include information taken from the group consisting of: republican voting history, democratic voting history, republican indicators, democratic indicators, right to life/abortion indicators, bumper stickers, tax indicators, home schooling indicators, gun rights/gun control indicators, sports indicators, flags, government comments and yard signs.

3. The system of claim 1 wherein said user authorization information includes user type selected from the group consisting of: national administrator, national user, state administrator, state user, county administrator, county user, precinct administration and precinct administrator.

4. The system of claim 3 wherein said set of computer readable instructions for constructing a set of streets within a predetermined proximity to said portable computer device based upon said operational location includes only streets within the county associated with the user for county users.

5. The system of claim 3 wherein said set of computer readable instructions for constructing a set of streets within a predetermined proximity to said portable computer device based upon said operational location includes only streets within the precinct associated with the user for precinct users.

6. The system of claim 1 wherein said computer readable instructions for determining if said manual operational location include instructions for determining if said user can view supporter information in said manual operational location and if so, settling said operational location to said manual operational location.

7. The system of claim 1 wherein said supporter information includes campaign information taken from the group comprising of: supporter, volunteer, donor, sign, bumper sticker, t-shirt and host.

8. The system of claim 1 wherein said computer readable instructions for generating a set of voters organized by precinct, indicating which voter in said set is a supporter, volunteer or donor, transmitting said set of voters to said portable computer device, receiving voter information from a user serving as a poll watcher indicating whether a selected voter from said set has voted, generating a subset of voters from said set of voters that are supporters, volunteers and donors that have not voted and transmitting said subset to a computer device so that supporters, volunteers and donors can be contacted and reminded to vote.

9. The system of claim 1 wherein said subset of voters includes phone number and email contact information for the voters that have not yet voted.

10. The system of claim 1 wherein said computer readable instructions for generating a report includes instructions for generating a report having a set of voters organized by precinct and indicating in said report which voter in said set is a supporter, volunteer or donor so that a poll watch report can be provided to a poll watcher.

11. The system of claim 10 wherein said computer readable instructions for generating a report includes instructions for generating a report having a set of voters including voter with voter clues indicating the voter is likely to support the campaign.

12. The system of claim 10 wherein said computer readable instructions for generating a report includes instructions for generating a report having a set of voters including voter with survey results indicating that the voter is likely to support that campaign.

13. The system of claim 10 wherein said computer readable instructions include instructions for receiving voter information from a user serving as a poll watcher, updating said set of voters to indicate which voter has voted and which voter has not, generating a subset of voters from said set of voters that are supporters, volunteers and donors that have not voted and generating a report showing which voter is a supporter, volunteer or donor that has not yet voted so that such voter can be can be contacted and reminded to vote.

14. The system of claim 10 wherein said computer readable instructions include instructions for receiving voter information from a user serving as a poll watcher, generating a subset of likely supporters that have not voted, transmitting said subset with voter information to a computer device so that a user of said computer device can determine whether to contact said likely supporter or not to remind the likely support to vote.

15. The system of claim 1 wherein said computer readable instructions include instructions for receiving voter information from a user serving as a poll watcher, updating said set of voters to indicate which voter has voted and which voter has not, generating a subset of voters from said set of voters that are supporters, volunteers and donors that have not voted transmitting said subset to a computer device so that a user of said computer device can receive real time information concerning the number of supporters, volunteers and donors that have voted compared to those that have not voted.

16. A dynamic supporter analysis system for mobilizing supporters comprising:
a central server, said central server having a non-transitory computer readable medium and in communications with a portable computer device;
a user database in communications with said central server having user records containing user information;
a voter database in communications with said central server having voter records containing supporter information, said user information includes voting clues taken from the group consisting of: republican voting history, democratic voting history, republican indicators, democratic indicators, right to life/abortion indicators, bumper stickers, tax indicators, home schooling indicators, gun rights/gun control indicators, sports indicators, flags, government size indicators and yard signs; and,
a set of computer readable instructions embodied in said central server that, when executed by a processor included in said central server, adapts said central server to perform the functions of: receiving the geographical location of the portable computing device, determining an initial operational location from said geographical location of said portable computer device, transmitting said initial operational location to said portable computer device, receiving an acceptance or rejection by the user of said initial operational location, if said initial operational location is accepted, setting said operational location to said initial operational location, if said initial operational location is rejected, retrieving a manual operational location from said portable computer device and settling said operational location to said manual operational location, constructing a set of streets within a predetermined proximity to said portable computer device based upon said operational location, retrieve voter records according to said streets to construct a set of target supporters located on at least one street in said set of streets, transmitting said target supporters to said portable computer device, receiving supporter selection information from said portable computer device, transmitting supporter information for said selected supporter, receiving supporter update information from said portable computer device and updating said voter record of said selected supporter with said supporter update information, generate a report and transmit said generated report to a computer device.

17. The system of claim 16 wherein said computer readable instructions include instructions for selecting records from said voter database that can be selected using filters selected from the group consisting of: state, county, precinct, street, postal code, age, household income, survey results, voting history and clues and transmitting said selected records to said portable computing device or a computing device.

18. The system of claim 16 wherein said computer readable instructions include instructions for determining if said selected supporter is a donor, transmitting instructions to said portable computing device requesting said user of said portable computing device to request a donation, receiving donation information indication whether or not said selected supporter made a donation, updating said record of said selected supporter to indicate that a donation request was made and said information concerning whether a donation was actually made or not.

19. A dynamic supporter analysis system for mobilizing supporters comprising:
a central server, said central server having a non-transitory computer readable medium and in communications with a portable computer device;
a voter database in communications with said central server having voter records containing supporter information and voting clues; and,
a set of computer readable instructions embodied in said central server that, when executed by a processor included in said central server, adapts said central server to perform the functions of: receiving the geographical location of the portable computing device, determining an operational location from said geographical location of said portable computer device, constructing a set of streets within a predetermined proximity to said portable computer device based upon said operational location, retrieve voter records according to said streets and said clues to construct a set of target supporters located on at least one street in said set of streets, transmitting said target supporters to said portable computer device, receiving supporter selection information from said portable computer device, transmitting supporter information for said selected supporter, receiving supporter update information from said portable computer device and updating said voter record of said selected supporter with said supporter update information.

20. The system of claim 19 wherein said computer readable instructions include instructions for receiving voter information from said portable computing device representing whether said voter had voted, updating said voter database to indicate the voter has voted, generating a subset of voters from said set of voters that are supporters, volunteers and donors that have not voted, transmitting said subset to a computer device so that a user of said computer device can receive real time information concerning the number of supporters, volunteers and donors that have voted compared to those that have not voted.
